(19) United States
(12) Patent Application Publication
(10) Pub. No.: US 2017/0009447 A1
(43) Pub. Date: Jan. 12, 2017

(54) TUNED SLOSHING DAMPER WITH BOTTOM-MOUNTED RIBS

(71) Applicant: Rowan Williams Davies & Irwin Inc., Guelph (CA)

(72) Inventors: Joseph Shayne Love, Guelph (CA); Andrew William Smith, Guelph (CA); Trevor Colin Haskett, Guelph (CA)

(73) Assignee: Rowan Williams Davies & Irwin Inc., Guelph (CA)

(21) Appl. No.: 15/206,666

(22) Filed: Jul. 11, 2016

Related U.S. Application Data
(60) Provisional application No. 62/190,792, filed on Jul. 10, 2015.

(51) Int. Cl. E04B 1/98; F16F 7/10; E04H 9/02

(52) U.S. Cl. CPC E04B 1/985; E04H 9/021; E04H 9/028; F16F 7/1034; E04H 2009/026

(57) ABSTRACT

A system for damping movement of a structure. The system includes an enclosure located in the structure in a predetermined position therein and having side walls and a floor. A liquid is positioned in the enclosure. The side walls include two first side walls positioned parallel to each other defining a first direction orthogonal to the first side walls and two second side walls positioned parallel to each other defining a second direction orthogonal to the second side walls. The system also includes a number of ribs positioned inside the enclosure and parallel to the second side walls, the ribs defining respective troughs therebetween. The enclosure is configured for imparting a predetermined first sloshing frequency to the liquid moving in the first direction, and for imparting a predetermined second sloshing frequency to the liquid moving in the second direction.

This application claims the benefit of U.S. Provisional Patent Application No. 62/190,792, filed on Jul. 10, 2015, the disclosure of which is fully incorporated herein by reference.

### FIELD OF THE INVENTION

The present invention is a system for damping movement of a structure.

### BACKGROUND OF THE INVENTION

A structure that is rectangular in plan view, or generally so, has two dimensions generally defining it that are orthogonal to each other, i.e., a short dimension, and a long dimension. As is well known in the art, the structure has at least two different natural frequencies of the respective structural modes (i.e., across the short dimension, and across the long dimension). The short and long dimensions are measured between longer exterior walls and shorter exterior walls respectively. Typically, the natural frequency of the structure across the short dimension is higher than the natural frequency across the long dimension.

As is known, a bidirectional tuned sloshing damper may be positioned at or near an upper end of a tall structure, e.g., a multi-storey office or residential building having a generally rectangular configuration in plan view, for damping movement of the structure. In the prior art, the bidirectional tuned sloshing damper typically includes an enclosure or tank structure with a floor and four vertical walls, to contain a volume of water. The sloshing damper may also have a short dimension and a long dimension that are substantially aligned with the short and long dimensions of the tall structure respectively. The sloshing damper is “tuned”, i.e., it is formed so that water in the damper has natural sloshing frequencies across each of the short and the long dimensions of the tank that are predetermined relative to the corresponding natural frequencies of the respective structural modes of the tall structure. Typically, the natural sloshing frequency in one direction is predetermined to be only slightly less than the natural sloshing frequency of the structure in that direction. However, other arrangements may be selected, depending on the circumstances. For instance, where multiple tuned sloshing dampers are used in a tall structure, it may be advantageous for one or more of the natural sloshing frequencies to be greater than, or equal to, the corresponding natural frequency of the tall structure.

It has been found that the water sloshing at the natural sloshing frequency in the tank dampens the respective bidirectional movements of the tall structure at its natural frequencies, because of the small but important differences between the natural frequencies of the tall structure and the respective corresponding natural sloshing frequencies of the tank.

In its simplest version, because the water has the same depth throughout the entire tank enclosure, the natural sloshing frequencies are determined by the relative positions of the walls of each pair and the depth of the water in the tank.

There have been found to be a number of problems with this fairly straightforward approach. First, it may not be possible, or feasible, to build the tank with the appropriate dimensions to provide the appropriate bidirectional natural sloshing frequencies.

Second, it typically does happen that the tall structure as built has natural frequencies that are materially different from the natural frequencies of the tall structure as designed. Because of these differences, it frequently happens that an original design for the tank, i.e., based on the design of the tall structure, does not result in bidirectional natural sloshing frequencies that are appropriate, in view of the tall structure's actual natural frequencies.

Accordingly, the design of the tank typically is required to be revised to take the differences between the design of the tall structure, and the tall structure as built, into account. The redesign of the tank and its installation typically are required to be done within a relatively short time period during construction of the tall structure. As a practical matter, this means that any amendments to the tank design (i.e., to adjust the natural sloshing frequencies thereof, in view of the natural frequencies of the tall structure as built) are required to be made within a relatively short time period. Where varying the dimensions of the tank is the only way to change the natural sloshing frequencies, such variations may be difficult to effect in a relatively short time period.

### SUMMARY OF THE INVENTION

For the foregoing reasons, there is a need for a tuned sloshing damper that overcomes or mitigates one or more of the disadvantages or defects of the prior art. Such disadvantages or defects are not necessarily included in those described above.

In its broad aspect, the invention provides a system for damping movement of a structure. The system includes an enclosure located in the structure in a predetermined position therein and at least partially defined by side walls and a floor. The system also includes a liquid positioned therein, to an overall depth. The side walls include a first pair of two first side walls, the first side walls being positioned parallel to each other to define a first direction that is substantially orthogonal to the first side walls. The side walls also include a second pair of two second side walls, the second side walls being positioned parallel to each other to define a second direction substantially orthogonal to the second side walls, the first and second directions being substantially orthogonal to each other. The system also includes a number of ribs positioned inside the enclosure and parallel to the second side walls, the ribs defining respective troughs therebetween, each rib having a preselected rib height above the floor to define a rib depth of the liquid that is positioned in the troughs, the liquid in each trough being at least partially impeded from movement in the second direction by the ribs defining each trough respectively. The first side walls are located a preselected first distance apart from each other respectively, the first distance being selected for imparting a predetermined first sloshing frequency to the liquid moving in the first direction when the structure is moved at least partially in the first direction at a first natural frequency of the structure. The second side walls are located a preselected second distance apart from each other, and the ribs are located at preselected rib separation distances from the respective ribs proximal thereto respectively, the second distance, the rib height, and the rib separation distances being selected for imparting a predetermined second sloshing frequency to the liquid moving in the second direction when the structure is moved at least partially in the second direction at a second natural frequency of the structure. The first and second sloshing frequencies are selected relative to the first and second natural frequencies of the structure respectively, to dampen movement of the structure in the first and second directions respectively.

In another of its aspects, the invention provides a system for damping movement of a structure. The system includes an enclosure located in the structure in a predetermined position therein and at least partially defined by side walls and a floor. The system also includes a liquid positioned in the enclosure to an overall depth. The side walls include a first pair of two first side walls, the first side walls being positioned parallel to each other to define a first direction that is substantially orthogonal to the first side walls. The side walls also include a second pair of two second side walls, the second side walls being positioned parallel to each other to define a second direction substantially orthogonal to the second side walls, the first and second directions being substantially orthogonal to each other. The system also includes a number of ribs positioned inside the enclosure and parallel to the second side walls, the ribs defining respective troughs therebetween, each rib having a preselected rib height above the floor to define a rib depth of the liquid that is positioned in the troughs, the liquid in each trough being at least partially impeded from movement in the second direction by the ribs defining each trough respectively. In addition, the system includes a number of paddles at least partially positioned in the liquid, the paddles being spaced apart from each other respectively by a first paddle distance in the first direction and by a second paddle distance in the second direction. The first side walls are located a preselected first distance apart from each other, the first distance and the first paddle distance being selected for imparting a predetermined first sloshing frequency to the liquid moving in the first direction when the structure is moved at least partially in the first direction at a first natural frequency of the structure. The second side walls are located a preselected second distance apart from each other, and the ribs are located at preselected rib separation distances from each other, the second distance, the second paddle distance, and the rib separation distances being selected for imparting a predetermined second sloshing frequency to the liquid moving in the second direction when the structure is moved at least partially in the second direction at a second natural frequency of the structure. The first and second sloshing frequencies are selected relative to the first and second natural frequencies of the structure respectively, to dampen movement of the structure in the first and second directions respectively.

### BRIEF DESCRIPTION OF THE DRAWINGS

The invention will be better understood with reference to the attached drawings, in which:

FIG. 1 is a top view of an embodiment of the tuned sloshing damper system of the invention, installed in a structure;

FIG. 2 is a side view of the structure of FIG. 1, drawn at a smaller scale;

FIG. 3 is a top view of the tuned sloshing damper system of FIGS. 1 and 2, drawn at a larger scale;

FIG. 4A is a cross-section of the tuned sloshing damper system of FIG. 3 taken along line A-A in FIG. 3, drawn at a larger scale;

FIG. 4B is a cross-section of an alternative embodiment of the tuned sloshing damper system of the invention;

FIG. 5 is a top view of an alternative embodiment of the tuned sloshing damper system of the invention, drawn at a smaller scale; and

FIG. 6 is a cross-section of the tuned sloshing damper system of FIG. 5 taken along line B-B in FIG. 5, drawn at a larger scale.

### DETAILED DESCRIPTION

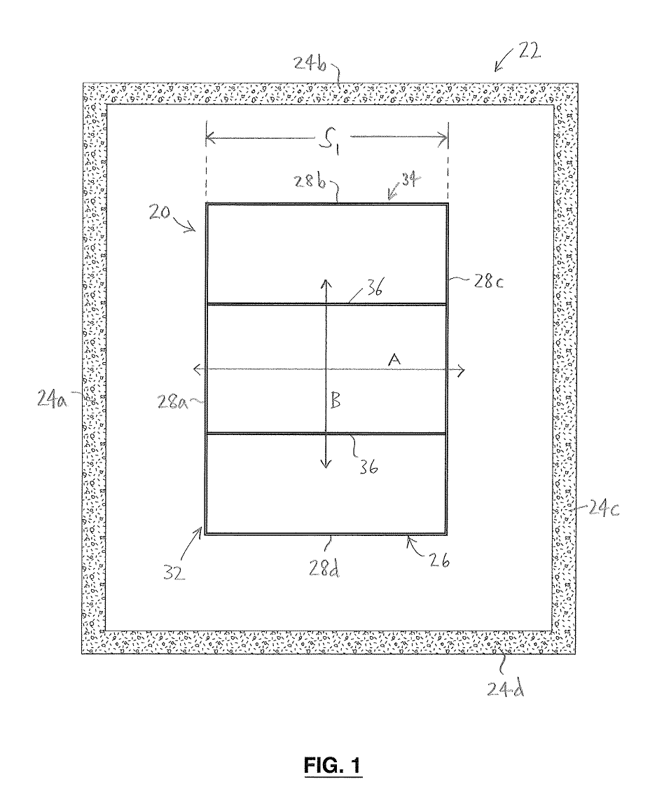

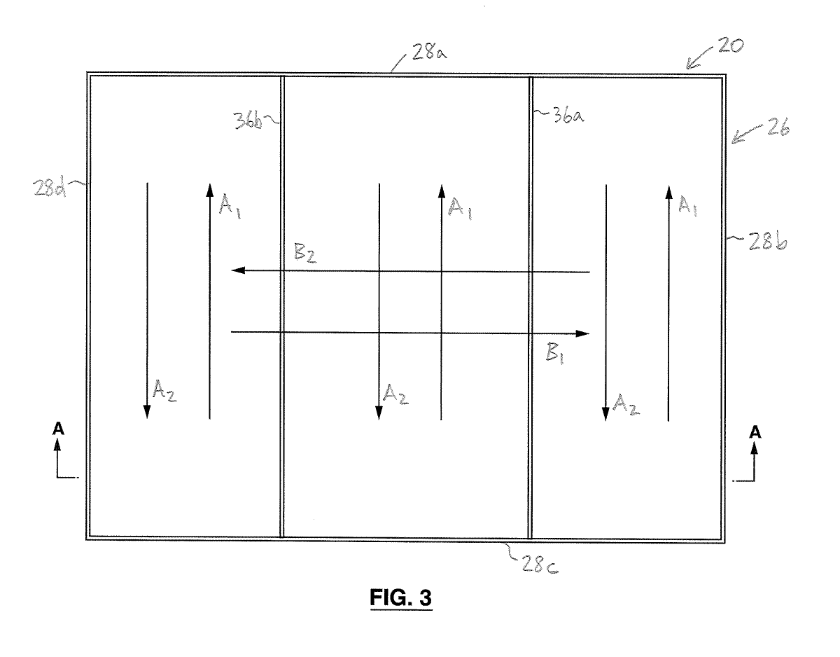

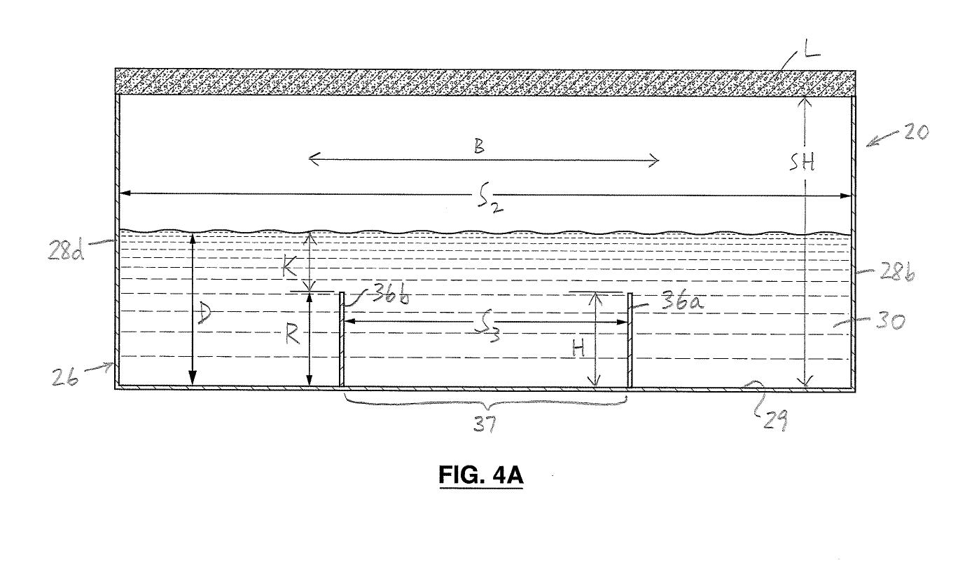

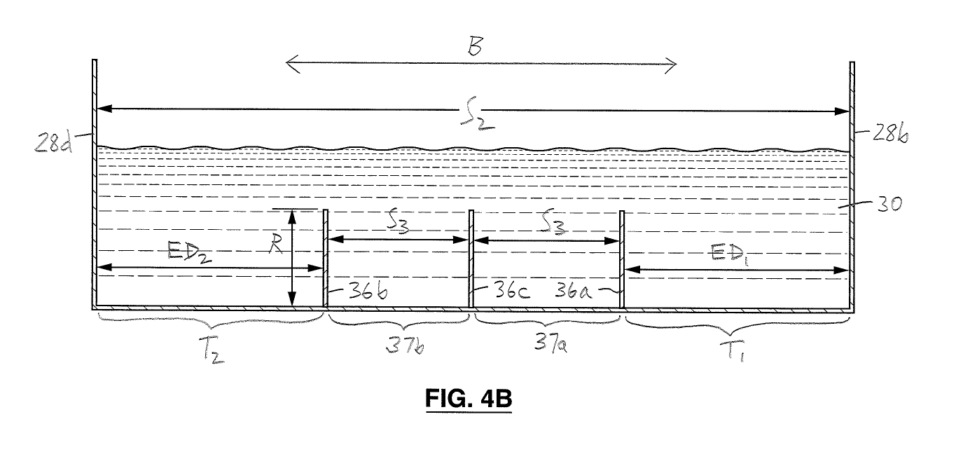

In the attached drawings, like reference numerals designate corresponding elements throughout. Reference is first made to FIGS. 1-4A to describe an embodiment of a system including a tuned sloshing damper in accordance with the invention indicated generally by the numeral 20. The system 20 is for damping movement of a structure 22. In one embodiment, the system 20 preferably includes an enclosure 26 preferably located in the structure 22 in a predetermined position therein at least partially defined by side walls 28 (identified for convenience as side walls 28a-28d respectively in FIG. 1) and a floor 29. The system 20 also preferably includes a liquid 30 positioned in the enclosure 26, to an overall depth “D” (FIG. 4A), as will be described. Preferably, the side walls 28 include a first pair 32 of two first side walls (identified in FIG. 1 by reference numerals 28a, 28c). As can be seen in FIG. 1, the first side walls 28a, 28c preferably are positioned parallel to each other to define a first direction (identified by arrow “A” in FIG. 1) that is substantially orthogonal to the first side walls 28a, 28c. The side walls 28 preferably also include a second pair 34 of two second side walls (identified in FIG. 1 by reference numerals 28b, 28d). The second side walls 28b, 28d preferably are positioned parallel to each other to define a second direction (identified by arrow “B” in FIG. 1). As can be seen in FIG. 1, the first and second directions are orthogonal to each other. It is also preferred that the system 20 includes a number of ribs 36 positioned inside the enclosure 26 parallel to the second side walls 28b, 28d. Preferably, the ribs 36 define respective troughs 37 therebetween. It is also preferred that each of the ribs 36 has a preselected rib height “R” above the floor 29 to define a rib depth “H” of the liquid that is positioned in the troughs 37. As will be described, the liquid 30 in each trough 37 is at least partially impeded from movement in the second direction by the ribs 36 (FIGS. 3, 4A) defining each of the troughs 37 respectively. (As illustrated in FIGS. 1-4A, the ribs affect the natural sloshing frequency in the second direction.) As can be seen in FIG. 4A, the rib height “R” and the rib depth “H” of the liquid in the trough 37 are the same.

In one embodiment, the first side walls 28a, 28c preferably are located a preselected first distance “S₁” apart from each other respectively. The first distance “S₁” is selected for imparting a predetermined first sloshing frequency to the liquid 30 moving in the first direction when the structure 22 is moved at least partially in the first direction at a first natural frequency of the structure. Preferably, the second side walls 28b, 28d are located a preselected second distance “S₂” apart from each other. It is also preferred that the ribs 36 are located at preselected rib separation distances “S₃” from the respective ribs proximal thereto respectively. The second distance “S₂”, the rib height “R”, and the rib separation distances “S₃” being selected for imparting a predetermined second sloshing frequency to the liquid 30 moving in the second direction when the structure 22 is moved at least partially in the second direction at a second natural frequency of the structure. It is also preferred that the first and second sloshing frequencies are selected relative to the first and second natural frequencies of the structure respectively, to dampen movement of the structure in first and second directions respectively.

In FIGS. 1, 3, and 4A, only two ribs (identified in FIGS. 3 and 4A by reference numerals 36a and 36b for convenience) are shown. However, it will be understood that the system may include any suitable number of ribs. For instance, an alternative embodiment of the system 20 is illustrated in FIG. 4B, in which three ribs (identified in FIG. 4B by reference numerals 36a, 36b, and 36c for convenience) are included. As can be seen in FIG. 4B, in one embodiment, the rib separation distances “S₃” preferably are substantially equal. This can be seen in FIG. 4B, in which the rib 36a is separated from the rib 36c by the distance “S₃”, and the rib 36b is separated from the rib 36c by the same distance. Also, the ribs 36 preferably are spaced apart from the second side walls by predetermined equal end distances. For instance, in FIG. 4B, the ribs identified therein as 36a and 36b for convenience are spaced apart from the second side walls 28b, 28d by end distances respectively identified as “ED₁” and “ED₂”. As can be seen in FIG. 4B, the end ribs 36a, 36b define respective end troughs “T₁”, “T₂” located between the end ribs 36a, 36b and the second side walls 28b, 28d respectively. The end troughs “T₁”, “T₂” have respective depths equal to the respective heights of the end ribs 36a, 36b (FIG. 4B). As can be seen in FIG. 4B, for example, the rib height is “R”, and therefore the troughs “T₁” and “T₂” have the depth “R”.

For convenience, the trough defined by the ribs 36a and 36c illustrated in FIG. 4B is identified by reference numeral 37a, and the trough defined by the ribs 36b and 36c is identified by reference numeral 37b.

It will also be understood that, in an alternative embodiment (not shown), the ribs 36 may be positioned parallel to the first side walls 28a, 28c.

It will also be understood that the side walls 28 and the ribs 36 may have any suitable configurations. As illustrated in FIGS. 1, 3, and 4A, for example, in one embodiment, the first and second side walls and the ribs 36 preferably are substantially straight.

The liquid 30 may be any suitable liquid. It has been found that water is a suitable liquid.

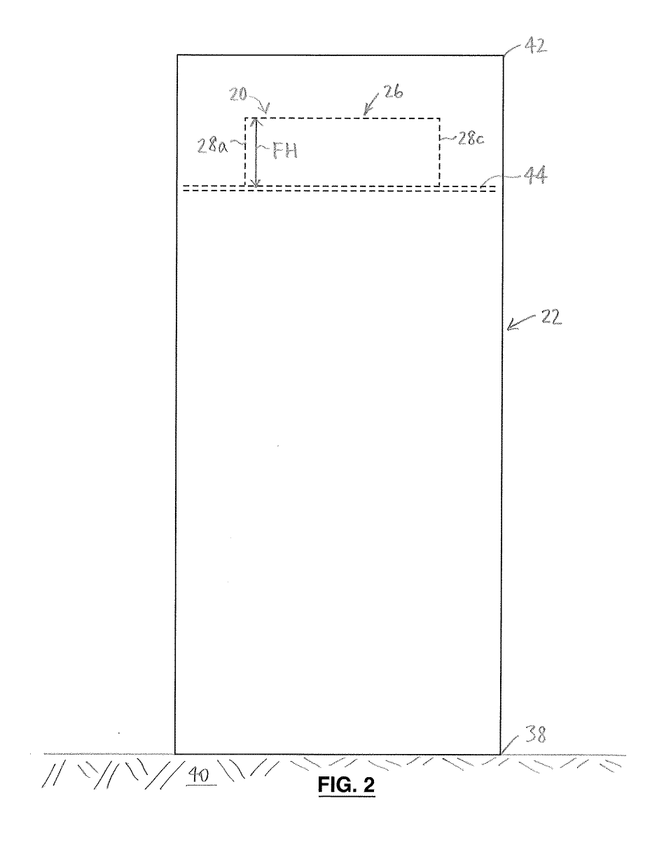

It is also preferred that each of the first side walls 28a, 28c extends above the floor 29 to a first height “FH” above the floor 29. The first height “FH” preferably is sufficient to hold the liquid in the enclosure when the liquid is moving in the enclosure at the first and second sloshing frequencies (FIG. 2). Similarly, the second side walls 28b, 28d preferably extend to a second height “SH” above the floor 29. The second height “SH” preferably is sufficient to hold the liquid in the enclosure when the liquid is moving in the enclosure at the first and second sloshing frequencies. It will be understood that the heights of the first side walls and the second side walls preferably are substantially the same.

In one embodiment, the system 20 preferably includes a lid or cover element “L” (FIG. 4A). It will be understood that the cover element “L” is omitted, for clarity of illustration, from FIGS. 1-3 and 4B. Those skilled in the art would appreciate that the cover element “L” may serve certain purposes. For instance, where the liquid is water, the cover element “L” delays evaporation of the water. Also, the cover element “L” discourages the growth of algae in the water.

Those skilled in the art would appreciate that the sloshing frequency of the system 20 in a particular direction preferably is either slightly less, or slightly greater, than the natural frequency of the structure in such direction. That is, the sloshing frequency of the system 20 in a particular direction preferably is out of phase with the natural frequency of the structure in such direction.

In one embodiment, for example, it is preferred that the natural sloshing frequency in a particular direction is only slightly less than the natural frequency of the structure in such direction. For example, depending on a number of factors, the natural sloshing frequency may be approximately one per cent to five per cent less than the corresponding natural frequency of the structure. Those skilled in the art would be aware that, in certain circumstances, the predetermined natural sloshing frequency in a particular direction may preferably be greater than or approximately equal to the natural frequency of the structure in that direction.

Those skilled in the art would appreciate that the enclosure 26 may be constructed of suitable materials, in any suitable manner. In one embodiment, the enclosure 26 preferably includes the bottom wall 29 on which the ribs 36 are mounted, and to which the side walls 28 are secured.

In FIG. 1, the first direction is schematically indicated by double-ended arrow “A”, and the second direction is schematically indicated by double-ended arrow “B”. Those skilled in the art would appreciate that movement of the structure 22 may be initiated in various ways, e.g., by wind, or by an earthquake. It will be understood that the motion of the structure 22 may be initiated in the direction indicated by one of the ends of either of the arrows “A” or “B”. For example, if the structure 22 is pushed generally in the direction indicated by arrows “A₁” in FIG. 3, then the structure 22 will oscillate thereafter for a time period in the direction indicated by arrow “A” in FIG. 1, and also indicated by the arrows “A₁” and “A₂”. That is, once movement has been initiated, the structure 22 moves alternately in the directions indicated by the arrows “A₁”, “A₂” respectively in FIG. 3. Similarly, if the direction of initiated movement is indicated by arrow “B₁” in FIG. 3, the structure will oscillate as indicated by arrow “B”. That is, once movement has been initiated, the structure 22 moves alternately in the directions indicated by the arrows “B₁”, “B₂” respectively in FIG. 3.

As described above, the enclosure 26 is constructed so that the water 30 moving in the first direction is oscillating inside the enclosure 26 at the first sloshing frequency, and the movement of the water 30 in the second direction is at the second sloshing frequency. As noted above, in one embodiment, the first sloshing frequency preferably is close to (i.e., slightly less than, or slightly more than) the first natural frequency of the structure 22, i.e., the natural frequency of the structure in the first direction. Also, the second sloshing frequency preferably is close to (i.e., slightly less than, or slightly more than) the second natural frequency of the structure 22, i.e., the natural frequency of the structure in the second direction.

When the structure 22 is moved in the directions indicated by arrows “A” and/or “B”, such movement causes the water in the enclosure 26 to move in the same directions respectively. As described above, the oscillatory movement of the structure is at the relevant natural frequency of the structure. As noted above, however, the movement of the water 30 caused thereby will be at the relevant sloshing frequency. For instance, movement of the structure 22 in the first direction imparts corresponding movement to the water 30 in the first direction. Those skilled in the art would appreciate that, where the natural sloshing frequency is close to (i.e., either slightly greater than, or slightly less than) the corresponding natural frequency of the structure 22 in a particular direction (i.e., the first or second directions), the movement of the water in such direction is generally out of phase with the movement of the structure. In this way, the system operates to dampen oscillatory movement of the structure 22.

Those skilled in the art would also appreciate that, in practice, the movement of the structure 22, which may be initiated by, for example, wind, or an earthquake, may initially be in one or more directions that are not aligned with the first and second directions. However, due to the bidirectional orientation of the enclosure 26, the movement of the structure 22 in any direction (e.g., in the directions indicated by the arrows “A” and “B”, or in any other direction in the horizontal plane) causes the water 30 to move generally in the directions indicated by the arrows “A” and “B”. It will be understood that, when the structure 22 is moved in a direction that is neither the first nor the second direction, the movement imparted thereby to the water 30 is resolved into two components, i.e., one of which is aligned with arrow “A”, and the other of which is aligned with arrow “B”.

As illustrated in FIG. 1, the structure 22 has four exterior walls, identified for convenience as 24a-24d. In this example, the exterior walls 24a-24d define a substantially rectangular shape in plan view, and the side walls 28a-28d preferably are substantially parallel to the exterior walls 24a-24d respectively. That is, the enclosure 26 is illustrated in FIG. 1 in the predetermined position therefor in the structure.

However, it will be understood that the substantially rectangular enclosure 26 of the invention may be used in a structure having any shape or form, regular or irregular. As noted above, the movement of the structure that is imparted to the water 30 is resolved into two components thereof aligned orthogonally relative to the pairs 32, 34 of the side walls respectively, regardless of the direction of the initial movement of the structure 22.

It will also be understood that the side walls of the enclosure may not necessarily define a rectangle in plan view. The enclosure may have any suitable shape, and need not have a quadrilateral shape. Also, in practice, the side walls 28a-28d may not all be substantially straight along their respective lengths, because some deviations may be made to accommodate other elements in the structure, or related to it. The enclosure 26 may have the desired natural sloshing frequencies notwithstanding such deviations.

The ribs also may be formed and positioned in the enclosure in any suitable configuration. For instance, the ribs may be positioned in orientations relative to the side walls other than parallel to certain side walls, and shaped in any suitable form or forms.

It would also be appreciated by those skilled in the art that the natural sloshing frequencies are determined by a number of parameters. For example, for each natural sloshing frequency, the length of the enclosure 26 in the relevant direction (i.e., the first direction, or the second direction) and the depth of the water 30 in the enclosure are important parameters.

As described above, the ribs 36 are spaced equidistant apart from each other, and positioned parallel to selected side walls. For instance, in one embodiment, they are preferably positioned parallel to the side walls 28b, 28d. The ribs 36 preferably each have the same height, “R”. As can be seen, for example, in FIG. 4B, the water 30 located between the ribs 36 (i.e., in the troughs 37a, 37b) is generally prevented thereby from movement in the second direction. In addition, the water 30 located in the end troughs “T₁”, “T₂” is generally impeded from movement in the second direction by the ribs 36a, 36b and the second side walls 28b, 28d (FIG. 4B). In the embodiment as illustrated in FIG. 4B, the liquid in the two troughs 37 and the liquid in the two end troughs “T₁”, “T₂” is impeded from movement in the second direction to the depth “R”, i.e., the depth of each trough is equal to the height of the rib at least partially defining it.

In effect, in the embodiments illustrated in FIGS. 1, 3, 4A, and 4B, the ribs 36 reduce the effective depth of the water 30 with respect to the movement of the water 30 in the second direction. For instance, as illustrated in FIG. 4A, although the water in the enclosure 26 has an overall depth “D” (i.e., measured from the bottom wall 29), with respect to movement of the water in the second direction (i.e., across the ribs 36, in the direction indicated by arrow “B” in FIG. 1), the effective depth of the water for the purposes of the natural sloshing frequency is related to the difference between the overall height “D” of the water and the height “R” of the ribs 36. The water in the trough 37 (i.e., to a depth “R” that is defined by the ribs that define the trough) is effectively unable to move in the second direction. In FIG. 4A, this difference (i.e., the effective depth of the liquid 30 with respect to movement of the liquid in the second direction) is identified as “K”.

As can be seen in FIG. 4B, in one embodiment, the ribs 36 preferably are positioned apart from each other by a predetermined distance “S₃”. The ribs 36 also are spaced apart from the side walls 28b, 28d to which they are substantially parallel by predetermined distances “ED₁”, “ED₂”. In general, the ribs 36 preferably are positioned sufficiently proximal to each other that the water located in the troughs 37 between them (and in the end troughs “T₁”, “T₂” between the ribs 36 and the side walls 28b, 28d respectively) is at least partially prevented from movement in the second direction. As can be seen in FIG. 1, the enclosure 26 has an overall length “S₂” in the second direction, which is also taken into account in determining the natural sloshing frequency in the second direction.

It will be understood that the number of ribs positioned on the bottom wall, and as a result the spacing therebetween, may be varied as desired in order to provide the natural sloshing frequency desired in the direction orthogonal to the ribs. As noted above, the enclosure may include any suitable number of ribs. It will also be understood that, with a greater number of ribs, the depth of the water that is movable orthogonally relative to the ribs effectively decreases. This in turn has an effect on the natural sloshing frequency in the direction orthogonal to the ribs.

It will also be understood that the ribs 36 do not have a material effect on the depth of the water for the purposes of the sloshing frequency in the direction that is parallel to the ribs. For instance, as illustrated in FIGS. 1, 3, 4A, and 4B, the ribs 36 have virtually no effect on movement of the water in the first direction (i.e., in the direction indicated by arrow “A” in FIG. 1, and by the arrows “A₁”, “A₂” in FIG. 3). This means that, for the purposes of the first sloshing frequency in the embodiment illustrated in FIGS. 1-4B, the effective depth of the liquid is “D”, i.e., it is the same as the overall depth “D” of the liquid.

From the foregoing, it will also be understood that, although the ribs 36 are illustrated and described as being positioned to affect only the sloshing frequency of the water 30 moving in the second direction, alternatively, the ribs may instead be positioned to affect movement of the water in the first direction, i.e., to change the first sloshing frequency. This alternative embodiment is not illustrated in order to simplify the illustrations. In addition, the ribs may be positioned in the enclosure in any other suitable configuration.

Those skilled in the art would appreciate that the system 20 preferably is located, in the predetermined position therefor (i.e., with the side walls parallel to the walls of the structure, if the structure has a quadrilateral form), at the location in the structure 22 that is subjected to the greatest modal deflection. It would also be appreciated by those skilled in the art that this location depends on the structure's characteristics, and may not necessarily be at or near the upper end of the structure 22. However, in some cases, the location of the greatest modal deflection is at or proximal to an upper end of the structure.

An example of this is illustrated in FIG. 2. As shown in FIG. 2, the structure 22 extends between a lower end 38 secured in the ground 40 and an upper end 42 located at an elevation above ground level. As can also be seen in FIG. 2, in the structure 22 illustrated therein, the enclosure 26 preferably is located on a floor 44 that is generally proximal to the upper end 42 of the structure 22. It is preferred that the tuned sloshing damper 20 is located at or generally in the vicinity of the structure's upper end 42 because in this example, such location is at or near the location of the greatest modal deflection. In this example, the enclosure preferably is positioned also with its side walls substantially parallel to walls of the structure, i.e., the enclosure preferably is in the predetermined position of the enclosure 26 in the structure, and preferably is located at the location of the greatest modal deflection.

Those skilled in the art would appreciate that, in most cases, locating the enclosure 26 at the upper end 42 (i.e., in or just under the roof) may not be practical, or at least may be inconvenient. This means that the enclosure 26 may have to be built before the construction of the structure has been completed. In this situation, the “as built” data for the structure is not available when the side walls of the enclosure 26 are built.

In use, the enclosure 26 preferably is constructed when appropriate. For instance, the enclosure 26 may be constructed shortly before completion of the structure 22, i.e., after the structure 22 has mostly been completed, to allow the natural frequencies of the structure as built to be determined, or at least approximately determined. The ribs 36 preferably are included in the enclosure 26 as appropriate, to result in the enclosure 26 providing suitable natural sloshing frequencies in the first and second directions. Water is added into the enclosure 26, to the overall depth “D” that is required.

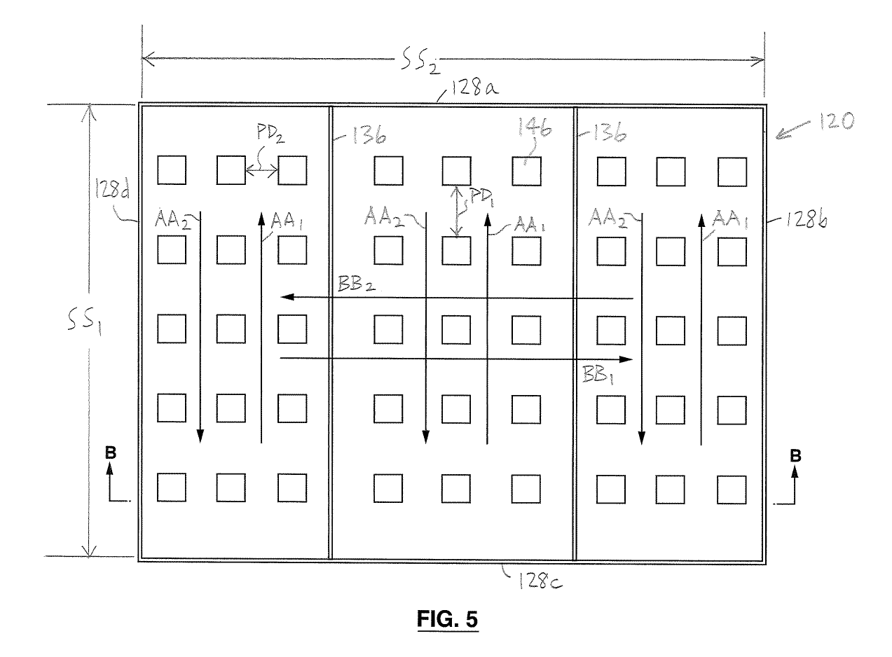

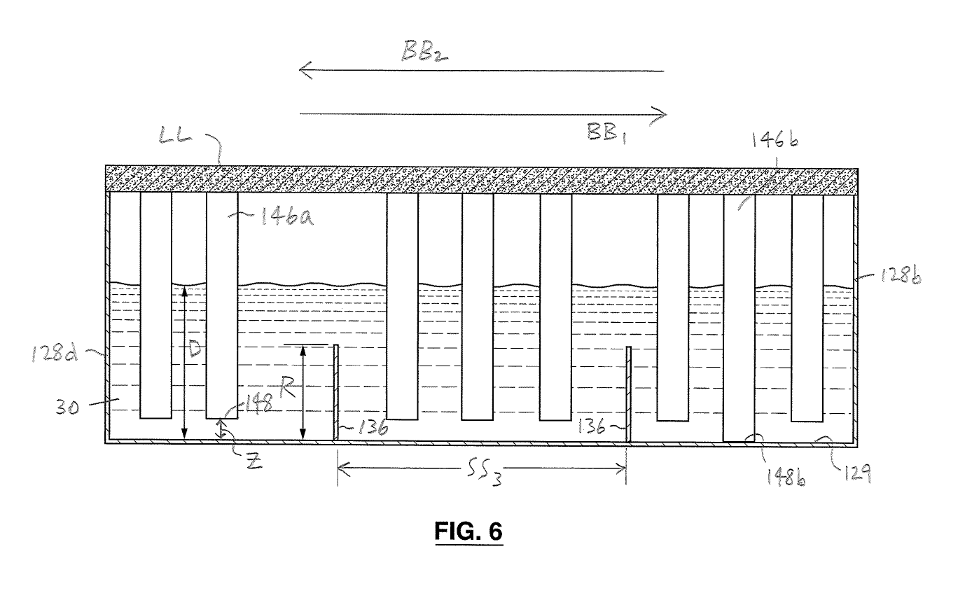

Those skilled in the art would appreciate that the system may additionally include other elements to provide additional means for adjusting the damping effect that is provided, and/or natural sloshing frequencies. For example, an embodiment of a system 120 is illustrated in FIGS. 5 and 6. As can be seen in FIG. 5, the system 120 preferably includes an embodiment 126 that includes side walls 128a, 128b, 128c, and 128d, a bottom wall 129, and ribs 136 mounted on the bottom wall 129. Preferably, two first side walls 128a, 128c are positioned parallel to each other, and two second side walls 128b, 128d are also positioned parallel to each other. The two first side walls 128a, 128c define a first direction that is orthogonal to the first side walls 128a, 128c. Also, the second side walls 128b, 128d define a second direction that is orthogonal to the second side walls 128b, 128d. The first and second directions are orthogonal to each other. As can be seen in FIG. 5, in one embodiment, the ribs 136 are positioned substantially orthogonal to the second direction (indicated by arrows “BB₁”, “BB₂” in FIG. 5) and substantially parallel to the first direction (indicated by arrows “AA₁”, “AA₂” in FIG. 5). (It will be understood that, in an alternative embodiment, the ribs 136 may be positioned substantially orthogonal to the first direction instead.)

In one embodiment, the system 120 preferably also includes one or more paddles 146. The paddles 146 are primarily designed for dissipation of an optimum amount of energy when the water is moving in the enclosure, i.e., the paddles cause a swirling turbulence in the moving water, lost as heat. However, the paddles 146 also affect the first and second sloshing frequencies. Accordingly, although the effect of the paddles 146 on the sloshing frequency is not their primary function, it is preferred that the paddles 146 are sized and positioned to result in the liquid having a predetermined attuned first sloshing frequency and a predetermined attuned second sloshing frequency, when the building is moved at least partially in the first direction and at least partially in the second direction, respectively, to dampen movement of the structure in the first and second directions respectively. Although the structure is not shown in FIGS. 5 and 6, it will be understood that the system 120 preferably is located in the structure in the same way that the other embodiment 20 of the system is located in the structure, i.e., preferably at a location of greatest modal deflection in the structure.

As illustrated in FIGS. 5 and 6, in one embodiment, the system 120 preferably includes a number of the paddles 146. As will be described, it is preferred that the paddles 146 are positioned spaced apart from the floor 129. As illustrated in FIGS. 5 and 6, the paddle 146 is a parallelepiped. However, the paddles 146 may have any suitable shape, or combination of shapes.

It will be understood that the paddles 146 at least partially obstruct the flow of the liquid 30 in each of the first and second directions. Preferably, the paddles 146 are positioned so that there is a gap (identified as “Z” in FIG. 6) between the bottom ends 148 thereof and the floor 129. For clarity of illustration, the paddle used to illustrate the gap “Z” is identified by reference numeral 146a in FIG. 6.

Alternatively, the paddles may be positioned with their bottom ends located on or in the floor 129. A paddle identified by reference numeral 146b for convenience is shown in FIG. 6 with its bottom end 148b located on the floor 129. This arrangement may be used where desirable.

It will also be understood that certain paddles 146 have been omitted from FIG. 6 for clarity of illustration. The paddles preferably are mounted so that they are in predetermined positions thereof in any suitable manner. For example, in one embodiment (as illustrated in FIG. 6), the paddles 146 preferably are mounted to the cover element “LL” in any suitable manner.

From the foregoing, it can be seen that the paddles 146 provide a means for further adjusting the damping effect on the structure's movement in both the first and second directions, although it is preferred that this is not their primary function. As can be seen in FIGS. 5 and 6, the ribs 136 may be used in a system 120 with the paddles 146. In the embodiment illustrated in FIGS. 5 and 6, the damping effect may be adjusted by adjustments to the paddles 146.

In the system 120, the ribs 136 preferably are used to adjust the sloshing frequency in the direction that is orthogonal to the ribs 136, as described above. From the foregoing, it will be appreciated that the paddles 146 preferably are spaced apart from each other respectively by a first paddle distance “PD₁” in the first direction and by a second paddle distance “PD₂” in the second direction. Also, as noted above, the first side walls are located a preselected first distance “SS₁” apart from each other. The first paddle distance “PD₁” and the first distance “SS₁” are selected for imparting a predetermined first sloshing frequency to the liquid moving in the first direction when the structure 22 is moved at least partially in the first direction, at a first natural frequency of the structure.

The second side walls are located a preselected second distance “SS₂” apart from each other, and the ribs 136 are located at a preselected rib separation distance “SS₃” from each other. The second distance “SS₂”, the second paddle distance “PD₂”, and the rib separation distance “SS₃” are selected for imparting a predetermined second sloshing frequency to the liquid moving in the second direction when the structure is moved at least partially in the second direction at the second natural frequency of the structure 22. As described above, the first and the second sloshing frequencies are selected relative to the first and second natural frequencies respectively, to dampen movement of the structure in the first and second directions respectively.

It will be appreciated by those skilled in the art that the invention can take many forms, and that such forms are within the scope of the invention as claimed. The scope of the claims should not be limited by the preferred embodiments set forth in the examples, but should be given the broadest interpretation consistent with the description as a whole.

We claim:

1. A system for damping movement of a structure, the system comprising:
an enclosure located in the structure in a predetermined position therein and at least partially defined by side walls and a floor;
a liquid positioned in the enclosure to an overall depth;
the side walls comprising:
a first pair of two first side walls, the first side walls being positioned parallel to each other to define a first direction that is substantially orthogonal to the first side walls;
a second pair of two second side walls, the second side walls being positioned parallel to each other to define a second direction substantially orthogonal to the second side walls, the first and second directions being substantially orthogonal to each other;
a plurality of ribs positioned inside the enclosure and parallel to the second side walls, the ribs defining respective troughs therebetween, each said rib having a preselected rib height above the floor to define a rib depth of the liquid that is positioned in the troughs, the liquid in each said trough being at least partially impeded from movement in the second direction by the ribs defining each said trough respectively;
the first side walls being located a preselected first distance apart from each other respectively, the first distance being selected for imparting a predetermined first sloshing frequency to the liquid moving in the first direction when the structure is moved at least partially in the first direction at a first natural frequency of the structure;
the second side walls being located a preselected second distance apart from each other, and the ribs being located at preselected rib separation distances from the respective ribs proximal thereto respectively, the second distance, the rib height, and the rib separation distances being selected for imparting a predetermined second sloshing frequency to the liquid moving in the second direction when the structure is moved at least partially in the second direction at a second natural frequency of the structure; and
the first and second sloshing frequencies being selected relative to the first and second natural frequencies of the structure respectively, to dampen movement of the structure in the first and second directions respectively.

2. A system according to claim 1 in which the rib separation distances are equal.

3. A system according to claim 1 in which the ribs are spaced apart from the second side walls by predetermined equal distances.

4. A system according to claim 1 in which the first side walls are substantially straight.

5. A system according to claim 1 in which the second side walls are substantially straight.

6. A system according to claim 1 in which the ribs are substantially straight.

7. A system according to claim 1 in which each of the first side walls extends above the floor to a first height above the floor, the first height being sufficient to hold the liquid when the liquid is moving in the enclosure at the first and second sloshing frequencies.

8. A system according to claim 1 in which each of the second side walls extends above the floor to a second height above the floor, the second height being sufficient to hold the liquid when the liquid in the enclosure is moving at the first and second sloshing frequencies.

9. A system according to claim 1 additionally comprising at least one paddle sized and positioned to result in the liquid having a predetermined attuned first sloshing frequency and a predetermined attuned second sloshing frequency, when the structure is moved at least partially in the first direction and at least partially in the second direction, respectively, to dampen movement of the structure in the first and second directions respectively.

10. A system according to claim 9 in which said at least one paddle is positioned spaced apart from the floor.

11. A system for damping movement of a structure, the system comprising:
an enclosure located in the structure in a predetermined position therein and at least partially defined by side walls and a floor;
a liquid positioned in the enclosure to an overall depth;
the side walls comprising:
a first pair of two first side walls, the first side walls being positioned parallel to each other to define a first direction that is substantially orthogonal to the first side walls;
a second pair of two second side walls, the second side walls being positioned parallel to each other to define a second direction substantially orthogonal to the second side walls, the first and second directions being substantially orthogonal to each other;
a plurality of ribs positioned inside the enclosure and parallel to the second side walls, the ribs defining respective troughs therebetween, each said rib having a preselected rib height above the floor to define a rib depth of the liquid that is positioned in the troughs, the liquid in each said trough being at least partially impeded from movement in the second direction by the ribs defining each said trough respectively;
a plurality of paddles at least partially positioned in the liquid, the paddles being spaced apart from each other respectively by a first paddle distance in the first direction and by a second paddle distance in the second direction;
the first side walls being located a preselected first distance apart from each other, the first distance and the first paddle distance being selected for imparting a predetermined first sloshing frequency to the liquid moving in the first direction when the structure is moved at least partially in the first direction at a first natural frequency of the structure;
the second side walls being located a preselected second distance apart from each other, and the ribs being located at preselected rib separation distances from each other, the second distance, the second paddle distance, and the rib separation distances being selected for imparting a predetermined second sloshing frequency to the liquid moving in the second direction when the structure is moved at least partially in the second direction at a second natural frequency of the structure; and
the first and second sloshing frequencies being selected relative to the first and second natural frequencies of the structure respectively, to dampen movement of the structure in the first and second directions respectively.

12. A system according to claim 11 in which:
the ribs comprise two end ribs positioned proximal to the second side walls respectively, to define two respective peripheral regions therebetween;
selected first ones of the paddles are positioned at least partially in the liquid in the troughs; and
selected second ones of the paddles are positioned at least partially in the liquid in the peripheral regions.

13. A method of damping movement of a structure extending between a lower end secured in the ground and an upper end located at an elevation above the ground, the structure having a location therein of greatest modal deflection, the method comprising:
(a) providing an enclosure substantially at said location in a predetermined position in the structure in which a liquid is to be held, the enclosure comprising a floor, a first pair of first side walls located parallel to each other and connected to each other by a second pair of said side walls, the second pair of second side walls being located parallel to each other, the first pair of the first side walls defining a first direction orthogonal thereto, and the second pair of the second side walls defining a second direction orthogonal thereto, the first pair of said side walls being located a preselected first distance apart from each other to impart a first sloshing frequency to the liquid in the first direction when the structure moves at least partially in the first direction at a first natural frequency, the first sloshing frequency being selected relative to the first natural frequency, to dampen movement of the structure in the first direction, and the second pair of the second side walls being located a preselected second distance apart from each other;
(b) positioning a plurality of substantially planar ribs on the floor, the ribs defining respective troughs therebetween, each said rib having a preselected rib height above the floor to define a rib depth of the liquid that is positioned in the troughs, the liquid in each said trough being impeded from movement in the second direction by the ribs defining each said trough respectively, the ribs being positioned substantially parallel to the second pair of the second side walls at preselected rib separation distances from the respective ribs proximal thereto, the second distance, the rib height, and the rib separation distances being selected to impart a second sloshing frequency to the liquid in the second direction when the structure moves at least partially in the second direction at a second natural frequency, the second sloshing frequency being selected relative to the second natural frequency, to dampen movement of the structure in the second direction; and
(c) positioning the liquid in the enclosure.

14. A method according to claim 13 additionally comprising:
(d) positioning at least one paddle in the enclosure, said at least one paddle being sized and positioned to result in the liquid having a predetermined attuned first sloshing frequency and a predetermined attuned second sloshing frequency when the structure is moved at least partially in the first direction and at least partially in the second direction, respectively, to dampen movement of the structure in the first and second directions respectively.

15. A method of damping movement of a structure extending between a lower end secured in the ground and an upper end located at an elevation above the ground, the structure having a location therein of greatest modal deflection, the method comprising:
(a) providing an enclosure substantially at said location in a predetermined position in the structure in which a liquid is to be held, the enclosure comprising a floor, a first pair of first side walls located parallel to each other and connected to each other by a second pair of said side walls, the second pair of second side walls being located parallel to each other, the first pair of the first side walls defining a first direction orthogonal thereto, and the second pair of the second side walls defining a second direction orthogonal thereto, the first pair of said side walls being located a preselected first distance apart from each other;
(b) positioning a plurality of substantially planar ribs on the floor, the ribs defining respective troughs therebetween, each said rib having a preselected rib height above the floor to define a rib depth of the liquid that is positioned in the troughs, the liquid in each said trough being impeded from movement in the second direction by the ribs defining each said trough respectively, the ribs being positioned substantially parallel to the second pair of the second side walls at preselected rib separation distances from the respective ribs proximal thereto;
(c) positioning a plurality of paddles in the enclosure and at least partially in the liquid, the paddles being spaced apart from each other by a first paddle distance in the first direction and spaced apart from each other by a second paddle distance in the second direction, the first distance and the first paddle distance being selected to impart a predetermined first sloshing frequency to the liquid moving in the first direction when the structure is moved at least partially in the first direction at a first natural frequency thereof, the first sloshing frequency being selected relative to the first natural frequency of the structure, to dampen movement of the structure in the first direction, and the second distance, the rib height, the rib separation distance, and the second paddle distance being selected to impart a second sloshing frequency to the liquid in the second direction when the structure moves at least partially in the second direction at a second natural frequency, the second sloshing frequency being selected relative to the second natural frequency, to dampen movement of the structure in the second direction; and
(d) positioning the liquid in the enclosure.

16. A building assembly comprising:
a structure extending between a lower end secured in the ground and an upper end located at an elevation above the ground, the structure having a location therein of greatest modal deflection;
a system for damping movement of the structure, the system comprising:
an enclosure located in the structure at said location in a predetermined position and at least partially defined by side walls and a floor;
a liquid positioned in the enclosure to an overall depth;
the side walls comprising:
a first pair of two first side walls, the first side walls being positioned parallel to each other to define a first direction that is substantially orthogonal to the first side walls;
a second pair of two second side walls, the second side walls being positioned parallel to each other to define a second direction substantially orthogonal to the second side walls, the first and second directions being substantially orthogonal to each other;
a plurality of ribs positioned inside the enclosure and parallel to the second side walls, the ribs defining respective troughs therebetween, each said rib having a preselected rib height above the floor to define a rib depth of the liquid that is positioned in the troughs, the liquid in each said trough being at least partially impeded from movement in the second direction by the ribs defining each said trough respectively;
the first side walls being located a preselected first distance apart from each other respectively, the first distance being selected for imparting a predetermined first sloshing frequency to the liquid moving in the first direction when the structure is moved at least partially in the first direction at a first natural frequency of the structure;
the second side walls being located a preselected second distance apart from each other, and the ribs being located at preselected rib separation distances from the respective ribs proximal thereto respectively, the second distance, the rib height, and the rib separation distances being selected for imparting a predetermined second sloshing frequency to the liquid moving in the second direction when the structure is moved at least partially in the second direction at a second natural frequency of the structure; and
the first and second sloshing frequencies being selected relative to the first and second natural frequencies of the structure respectively, to dampen movement of the structure in the first and second directions respectively.

17. A building assembly comprising:
a structure extending between a lower end secured in the ground and an upper end located at an elevation above the ground, the structure having a location therein of greatest modal deflection;
a system for damping movement of the structure, the system comprising:
an enclosure located in the structure at said location in a predetermined position and at least partially defined by side walls and a floor;
a liquid positioned in the enclosure to an overall depth;
the side walls comprising:
a first pair of two first side walls, the first side walls being positioned parallel to each other to define a first direction that is substantially orthogonal to the first side walls;
a second pair of two second side walls, the second side walls being positioned parallel to each other to define a second direction substantially orthogonal to the second side walls, the first and second directions being substantially orthogonal to each other;
a plurality of ribs positioned inside the enclosure and parallel to the second side walls, the ribs defining respective troughs therebetween, each said rib having a preselected rib height above the floor to define a rib depth of the liquid that is positioned in the troughs, the liquid in each said trough being at least partially impeded from movement in the second direction by the ribs defining each said trough respectively;
a plurality of paddles at least partially positioned in the liquid, the paddles being spaced apart from each other respectively by a first paddle distance in the first direction and by a second paddle distance in the second direction;
the first side walls being located a preselected first distance apart from each other, the first distance and the first paddle distance being selected for imparting a predetermined first sloshing frequency to the liquid moving in the first direction when the structure is moved at least partially in the first direction at a first natural frequency of the structure;
the second side walls being located a preselected second distance apart from each other, and the ribs being located at preselected rib separation distances from each other, the second distance, the second paddle distance, and the rib separation distances being selected for imparting a predetermined second sloshing frequency to the liquid moving in the second direction when the structure is moved at least partially in the second direction at a second natural frequency of the structure; and
the first and second sloshing frequencies being selected relative to the first and second natural frequencies of the structure respectively, to dampen movement of the structure in the first and second directions respectively.
